(19) United States
(12) Patent Application Publication
(10) Pub. No.: US 2012/0120050 A1
(43) Pub. Date: May 17, 2012

(54) Dual-mode two-dimensional/three-dimensional display

(75) Inventor: Toni Hemminki, Tampere (FI)

(73) Assignee: Nokia Corporation

(21) Appl. No.: 12/927,383

(22) Filed: Nov. 12, 2010

(51) Int. Cl. G09G 5/00; G06T 15/00

(52) U.S. Cl. 345/419

(57) ABSTRACT

In one exemplary embodiment, method includes: showing, in 2D mode, a two-dimensional image based on 2D data; in response to a trigger to switch the 2D mode to S3D mode to show a stereoscopic three-dimensional image, showing, in the S3D mode, a first intermediate image based on the 2D image data, the first intermediate image utilizes the 2D data as both left and right data for the S3D mode, where 3D data includes S3D left and right data; showing, in the S3D mode, a second intermediate image based on the 3D data, where the second intermediate image utilizes one of the S3D left and right data as both the left and right data for the S3D; and showing, in the S3D mode, the S3D image based on the 3D data, where the S3D image utilizes the S3D left and right data as the left and right image data.

### TECHNICAL FIELD

The exemplary and non-limiting embodiments of this invention relate generally to electronic device displays and, more specifically, relate to displays operable to show two-dimensional images or three-dimensional images.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

“Stereoscopy (also called stereoscopic or 3-D imaging) is any technique capable of recording three-dimensional visual information or creating the illusion of depth in an image.” Stereoscopy enhances the illusion of depth in a two-dimensional image by presenting a slightly different image to each eye. Wikipedia: Stereoscopy (accessed Oct. 18, 2010).

A stereoscopic display (e.g., on a mobile device) enables a viewer to see a stereoscopic three-dimensional (S3D) image using different images for the left eye and right eye. The device may have a dedicated memory to store the image data. Typically the memory size is matched to the panel resolution. For a S3D display there needs to be memory for both the left and right eyes (i.e., for the separate images that are shown for the left and right eyes). Some S3D panels have memory for 2× the resolution (i.e., 2× memory for native 2D-mode resolution) while others have memory only for 1× the resolution (i.e., 1× memory for native 2D-mode resolution), leading to the latter having a poorer quality of display. The system host will send the image data to the display panel memory, typically when the content on the display has changed or is changing.

### SUMMARY

The below summary section is intended to be merely exemplary and non-limiting.

In one exemplary embodiment of the invention, a method comprising: providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode; showing, on the display in the 2D mode, a two-dimensional image that is based on two-dimensional image data read from the memory; in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the memory, where the first intermediate image utilizes the two-dimensional image data as both the left image data and the right image data, where the three-dimensional image data comprises S3D left image data and S3D right image data; showing, on the display in the S3D mode, a second intermediate image that is based on at least a portion of the three-dimensional image data read from the memory, where the second intermediate image utilizes one of the S3D left image data and the S3D right image data as both the left image data and the right image data; and showing, on the display in the S3D mode, the stereoscopic three-dimensional image that is based on the three-dimensional image data read from the memory, where the stereoscopic three-dimensional image utilizes the S3D left image data as the left image data and the S3D right image data as the right image data.

In another exemplary embodiment of the invention, an apparatus comprising: a display; at least one processor; and at least one memory including computer program code, where the apparatus is configured to operate in a 2D mode or a S3D mode, where the display is configured to show a first image based on first image data in the 2D mode and where the display is configured to show a second image based on left image data and right image data in the S3D mode, the at least one memory and the computer program code being configured to, with the at least one processor, cause the apparatus at least to perform: showing, on the display in the 2D mode, a two-dimensional image that is based on two-dimensional image data read from the at least one memory; in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the at least one memory, where the first intermediate image utilizes the two-dimensional image data as both the left image data and the right image data, where the three-dimensional image data comprises S3D left image data and S3D right image data; showing, on the display in the S3D mode, a second intermediate image that is based on at least a portion of the three-dimensional image data read from the at least one memory, where, the second intermediate image utilizes one of the S3D left image data and the S3D right image data as both the left image data and the right image data; and showing, on the display in the S3D mode, the stereoscopic three-dimensional image that is based on the three-dimensional image data read from the at least one memory, where the stereoscopic three-dimensional image utilizes the S3D left image data as the left image data and the S3D right image data as the right image data.

In another exemplary embodiment of the invention, a method comprising: providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode; showing, on the display in the S3D mode, a stereoscopic three-dimensional image that is based on three-dimensional image data read from the memory, where the three-dimensional image data comprises S3D left image data and S3D right image data, where the stereoscopic three-dimensional image utilizes the S3D left image data as the left image data and the S3D right image data as the right image data; in response to a trigger configured to switch the apparatus from the S3D mode to the 2D mode in order to show a two-dimensional image that is based on two-dimensional image data, showing, on the display in the 2D mode, a first intermediate image that is based on the three-dimensional image data read from the memory, where the first intermediate image utilizes one of the S3D left image data and the S3D right image data as the first image data; showing, on the display in the 2D mode, a second intermediate image that is based on the two-dimensional image data read from the memory, where the second intermediate image utilizes the two-dimensional image data by reading the two-dimensional image data at least twice or by reading at least two copies of the two-dimensional image data; and showing, on the display in the 2D mode, the two-dimensional image that is based on the two-dimensional image data read from the memory, where the two-dimensional image utilizes the two-dimensional image data by reading the two-dimensional image data only once or by reading only one copy of the two-dimensional image data.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows the state of a host memory, display memory and display at various points in the switching process for a device switching from 2D to S3D;

FIG. 2 shows exemplary states of a host memory, display memory and display at various points in the switching process from 2D to S3D for an exemplary device in accordance with the exemplary embodiments of the invention;

FIG. 3 illustrates how the interleaving of the two images (A and B) actually may appear on an exemplary display;

FIG. 4 shows exemplary states of a host memory, display memory and display at various points in the switching process from S3D to 2D for an exemplary device in accordance with the exemplary embodiments of the invention;

FIG. 5 illustrates a simplified block diagram of an electronic device that is suitable for use in practicing the exemplary embodiments of the invention;

FIG. 6 illustrates an exemplary data path for an exemplary line interleaving S3D mode in accordance with various exemplary embodiments of the invention;

FIG. 7 depicts a flowchart illustrating one non-limiting example of a method for practicing the exemplary embodiments of the invention; and

FIG. 8 depicts a flowchart illustrating another non-limiting example of a method for practicing the exemplary embodiments of the invention.

### DETAILED DESCRIPTION

It is often desirable to provide a display that can show S3D images and two-dimensional (2D) images, for example, in case the display is to show a 2D image or in case the viewer would prefer to view a 2D image instead of a S3D image. Such a display may have at least two modes of operation including: one for S3D and another for 2D. Switching between these modes may be controlled by software (e.g., a display panel command), hardware (e.g., a physical switch) or a combination of software and hardware (e.g., a physical switch that triggers one or more program commands).

In the 2D mode, the display can show a 2D image, for example, by duplicating the 2D image data (e.g., to cover the images projected to the different eyes). In the S3D mode, the display can show a S3D image by using two sets of data: “left image data” and “right image data” directed to the left eye of the viewer and the right eye of the viewer, respectively. By providing a slightly different image for each eye, the display can show a S3D image (e.g., an image that includes the illusion of depth).

One potential issue with a combined display may be caused by the display using a common memory for both 2D and S3D images. That is, even while switching between 2D and S3D modes the display has to scan image data from the memory to display an image (e.g., on the display or on the display glass).

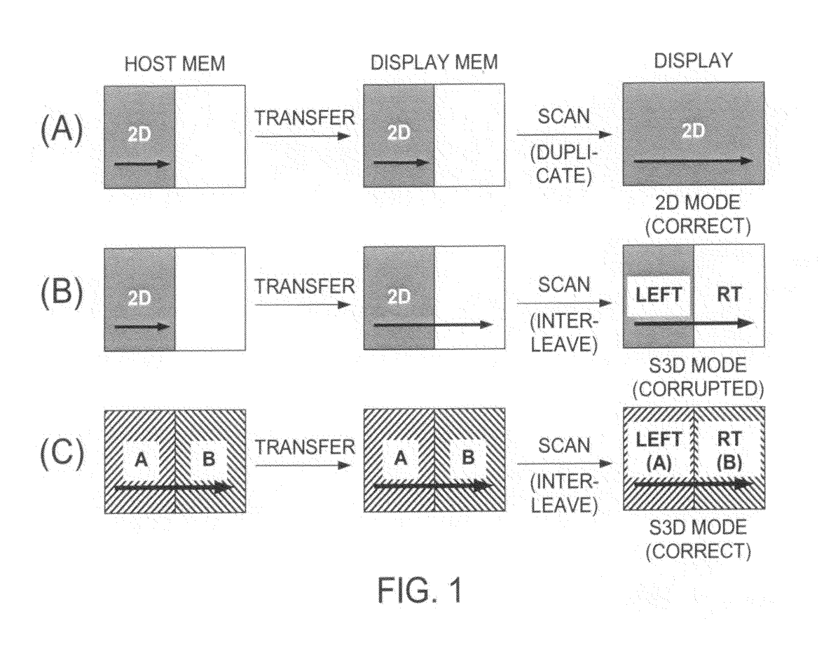

FIG. 1 illustrates a problem that arises when switching from 2D mode to S3D mode.

FIG. 1 shows the state of a host memory (“HOST MEM”), display memory (“DISPLAY MEM”) and display (“DISPLAY”) at various points in the switching process for a device switching from 2D to S3D. The device in FIG. 1 has memory for 2× the resolution. The arrows over the boxes indicate what is read when data is moved to the next stage (to the right on each line) with the last box in each row (the one for the display/display glass) indicating the drawing of the image on the display.

In FIG. 1A, a 2D-mode image is shown correctly. That is, the host memory stores image data for a 2D image. The display memory receives the 2D image data from the host memory. The 2D image data is scanned (duplicated) from the display memory to the display (e.g., a display glass) and, thus, the 2D image is correctly shown. Note that the panel duplicates (e.g., reads twice) all of the pixels for generating a 2D image on the 3D panel. The panel shows duplicated pixels for the left and right eyes, meaning there is no mask above the pixels in the display glass and, thus, no S3D image.

When a “switch to S3D” command is executed (e.g., in response to a user switching the mode, in response to the device detecting that a S3D image is to be displayed), there is a delay between execution of the command and correct displaying of the S3D image. The delay is due to the single display memory that is used for both 2D image data and S3D image data. Since the display memory initially stores 2D image data, this image data must be replaced by S3D image data before the S3D image can be shown correctly. In the meantime, the display glass is still showing an image (i.e., now a S3D image) based on the 2D image data.

FIG. 1B shows an intermediate period that occurs subsequent to execution of a “switch to S3D” command. The host memory still stores image data for the 2D image.

Accordingly, the display memory still receives the 2D image data from the host memory. Meanwhile, the display has been switched to the S3D mode. Thus, when the 2D image data is scanned (interleaved) from the display memory for viewing on the display in S3D mode, the resulting image is corrupted (i.e., it is incorrectly or erroneously shown).

FIG. 1C shows the subsequent correct viewing of the S3D image data. That is, the host memory has “caught up” and now stores S3D image data with separate images for the left and right eyes (left image data “A” and right image data “B”). The display memory then receives the correct S3D image data, which is scanned (interleaved) from the display memory for viewing on the display in S3D mode. Accordingly, the resulting S3D image is shown correctly.

With regards to FIG. 1, note that a similar problem arises for a 1 x memory and/or when switching from S3D mode to 2D mode.

One exemplary solution to address the above-noted issues is to better utilize the time critical host-panel controlling mechanism (e.g., faster switching between 2D mode and S3D mode). This exemplary solution may be difficult to implement and, furthermore, may incur additional costs (e.g., better and/or faster components, connections, processing and/or memory access).

Another exemplary solution would be to use different memories or different memory locations for the 2D image data and the S3D image data. However, in mobile devices it is desirable to minimize both the number of components needed (e.g., the number of memories) and the amount of memory consumed (utilized) by system processes (e.g., memory overhead). Furthermore, if additional memory were used this would increase the cost of the device and incur additional design concerns (e.g., additional physical space, connections and pathways needed for the additional memory).

Another exemplary solution would be to show a single color on the screen (e.g., a transition image of entirely black or entirely blue). In such a manner, any deficiencies or errors would be hidden during the transition. However, such a transition image would necessitate additional programming and/or storage (e.g., to store the transition image) and, furthermore, would be very disruptive to the viewing experience (e.g., 2D image to black screen to S3D image).

Another exemplary solution, and in accordance with the exemplary embodiments of the invention, is to utilize one or more additional and/or alternative phases (e.g. steps) when switching between 2D mode and S3D mode in order to reduce, minimize or avoid displaying a corrupted image during the switch/transition.

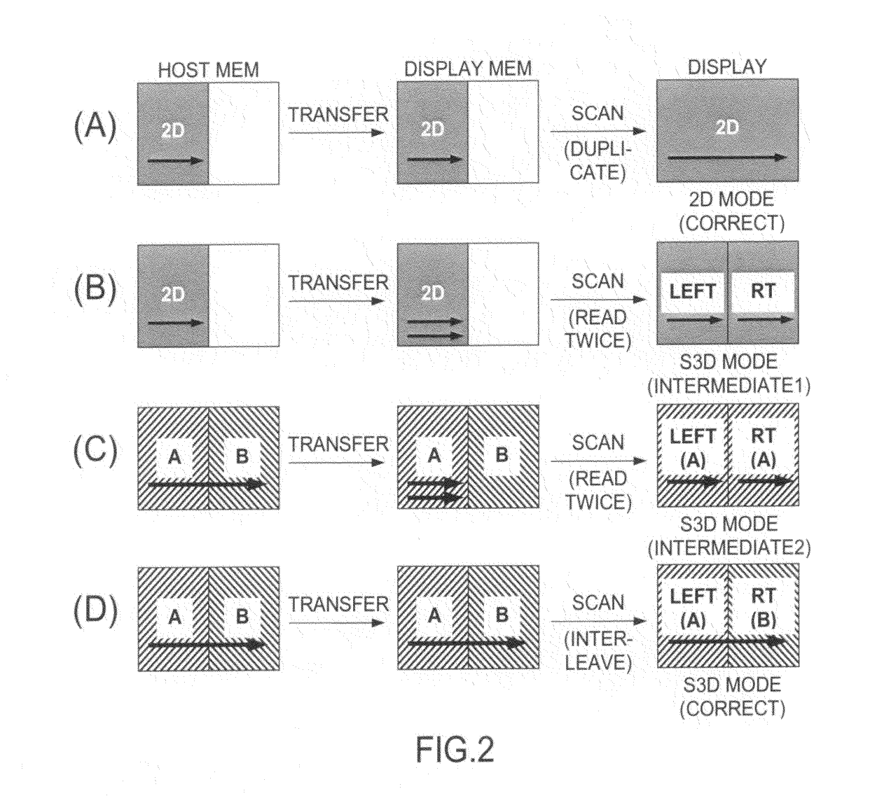

FIG. 2 shows exemplary states of a host memory (“HOST MEM”), display memory (“DISPLAY MEM”) and display (“DISPLAY”) at various points in the switching process from 2D to S3D for an exemplary device in accordance with the exemplary embodiments of the invention. The exemplary device has memory for 2× the resolution. The arrows over the boxes indicate what is read when data is moved to the next stage (to the right on each line) with the last box in each row (the one for the display/display glass) indicating the drawing of the image on the display.

In FIG. 2A, a 2D-mode image is shown correctly. That is, the host memory stores image data for a 2D image. The display memory receives the 2D image data from the host memory. The 2D image data is scanned (duplicated) from the display memory to the display (e.g., a display glass) and, thus, the 2D image is correctly shown. Note that the panel duplicates all of the pixels for generating a 2D image on the 3D panel. The panel shows duplicated pixels for the left and right eyes, meaning there is no mask above the pixels in the display glass (no S3D image).

When a “switch to S3D mode” command is executed to switch the transmitting mode from 2D to S3D (e.g., in response to a user switching the mode, in response to the device detecting that a S3D image is to be displayed), there is a delay between execution of the command and correct displaying of the S3D image. The delay is due to the single display memory that is used for both 2D image data and S3D image data. Since the display memory initially stores 2D image data, this image data must be replaced by S3D image data before the S3D image can be shown correctly. In the meantime, the display is still showing an image (i.e., now a S3D image) based on the 2D image data.

FIG. 2B shows a first intermediate period that occurs subsequent to execution of a “switch to S3D mode” command. The host memory still stores image data for the 2D image (e.g., because it has not been able to load the S3D image data yet). Accordingly, the display memory still receives the 2D image data from the host memory. Meanwhile, the display has been switched to the S3D mode. In order to prevent erroneous scanning of the 2D image data, the 2D image data in the display memory is read twice. When the display receives the data, it uses the same 2D image data for each of the two images (left image and right image) used to form the S3D image projected in the S3D mode. Since the device and/or display is in the S3D mode, the panel mask is enabled.

Subsequently (e.g., when a scanned frame changes, when scanning comes to the last pixel or the first pixel, when the host detects vertical synchronization interrupt—VSync IRQ), the host may start a direct memory access (DMA) transfer. That is, the host sends the “real” S3D image data which is comprised of left image data “A” and right image data “B”. Note that the display memory may be indexed differently from the host memory. While or after the S3D image data (“A” and “B” for the left image data and the right image data, respectively) is transferred, the display is still reading one of the sets of image data (e.g., the left image data A or the right image data B) twice. This is depicted in FIG. 2C for a second intermediate period that occurs subsequent to the first intermediate period. Accordingly, a same image data (e.g., the left image data A) is shown twice on the display (i.e., since the display is still reading a portion of the display memory twice to obtain the two sets of image data) and the resulting image is not in true/full S3D.

When the DMA transfer is complete, the host may begin the real or full S3D effect (e.g., by sending another command, such as a “switch to S3D mode” command or a “switch to real/full S3D mode” command, in response to the display detecting that data has been sent). As shown in FIG. 2D, this leads to the correct displaying of the S3D image data. That is, the host memory has “caught up” and now stores S3D image data with separate images for the left and right eyes (A and B). The display memory then receives the correct S3D image data, which is scanned (interleaved) from the display memory for showing on the display in S3D mode. Accordingly, the resulting S3D image is shown correctly (i.e., in true/real/full S3D).

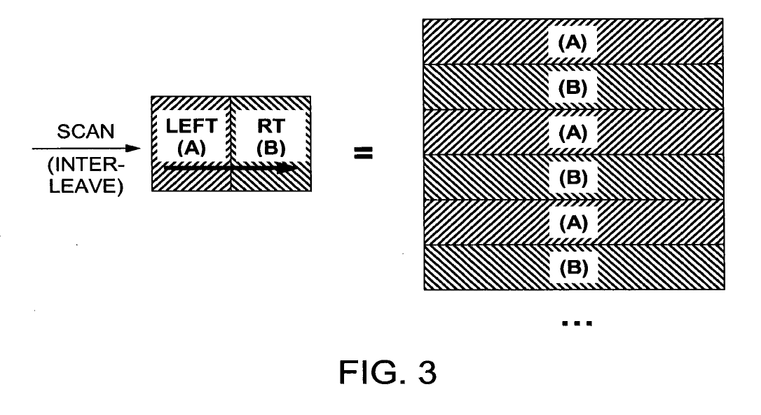

FIG. 3 illustrates how the two sets of data (the left image data A and the right image data B) in the S3D image data are interleaved for displaying on the display as a S3D image.

The “switch to real/full S3D mode” command noted above when transitioning from FIG. 2C to 2D is merely one example of a suitable mechanism. In other exemplary embodiments, an explicit command may not be used. For example, the utilization of the real/full S3D mode may be initiated automatically upon completion of the DMA transfer.

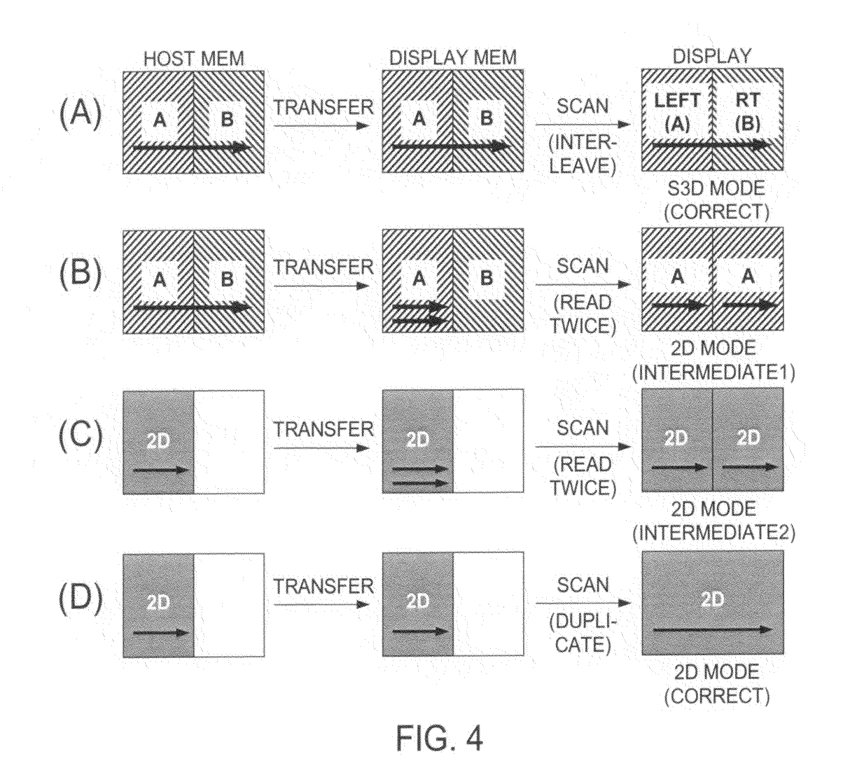

FIG. 4 shows exemplary states of a host memory (“HOST MEM”), display memory (“DISPLAY MEM”) and display (“DISPLAY”) at various points in the switching process from S3D to 2D for an exemplary device in accordance with the exemplary embodiments of the invention. The exemplary device has memory for 2× the resolution. The arrows over the boxes indicate what is read when data is moved to the next stage (to the right on each line) with the last box in each row (the one for the display/display glass) indicating the drawing of the image on the display.

In FIG. 4A, a S3D-mode image is shown correctly. That is, the host memory stores S3D image data, comprised of left image data “A” and right image data “B” (e.g., corresponding to separate images for the left eye and the right eye, respectively), for a S3D image. The display memory receives the S3D image data from the host memory. The S3D image data is scanned (interleaved) from the display memory for showing on the display in S3D mode. Since the device/display is operating in the S3D mode, a mask is active (e.g., above the pixels) to enable S3D viewing of the image(s).

When a “switch to 2D mode” command is executed (e.g., in response to a user switching the mode, in response to the device detecting that a 2D image is to be displayed), there is a delay between execution of the command and correct displaying of the 2D image. The delay is due to the single display memory that is used for both 2D image data and S3D image data. Since the display memory initially stores S3D image data, this image data must be replaced by 2D image data before the 2D image can be shown correctly. In the meantime, the display is still showing an image (i.e., now a 2D image) based on the S3D image data.

FIG. 4B shows a first intermediate period that occurs subsequent to execution of a “switch to 2D mode” command. The host memory still stores image data for the S3D image. Accordingly, the display memory still receives the S3D image data from the host memory. Meanwhile, the display has been switched to the 2D mode. In order to prevent erroneous scanning of the S3D image data, the S3D image data in the display memory is read twice (e.g., one of the images, A or B, is read twice while the other is not read). When the display receives the data, it uses the same S3D image data to form the 2D image projected in the 2D mode. Since the device and/or display is now in the 2D mode, the panel mask is disabled.

Subsequently (e.g., when the host detects vertical synchronization interrupt, VSync IRQ), the host may start a direct memory access (DMA) transfer. That is, the host sends the “real” 2D image data to the host memory. Note that the display memory may be indexed differently from the host memory. While or after the 2D image data is transferred, the display is still reading a portion of the 2D image data twice. This is depicted in FIG. 4C for a second intermediate period that occurs subsequent to the first intermediate period. Accordingly, the 2D image data is shown twice on the display (i.e., since the display is still reading a portion of the display memory twice) and the resulting image is not in true/full/correct 2D.

When the DMA transfer is complete, the host may begin the real, full, correct or accurate 2D effect (e.g., by sending another command, such as a “switch to 2D mode” command or a “switch to real/full/correct/accurate 2D mode” command). As shown in FIG. 4D, this leads to the correct displaying of the 2D image data. That is, the host memory has “caught up” and now stores 2D image data. The display memory then receives the correct 2D image data, which is scanned (duplicated) from the display memory for showing on the display in 2D mode. Accordingly, the resulting 2D image is shown correctly (i.e., in true/real/full 2D). Note that the panel duplicates all of the pixels for generating a 2D image on the 3D panel. The panel shows duplicated pixels for the left and right eyes, meaning there is no mask above the pixels in the display glass (no S3D image).

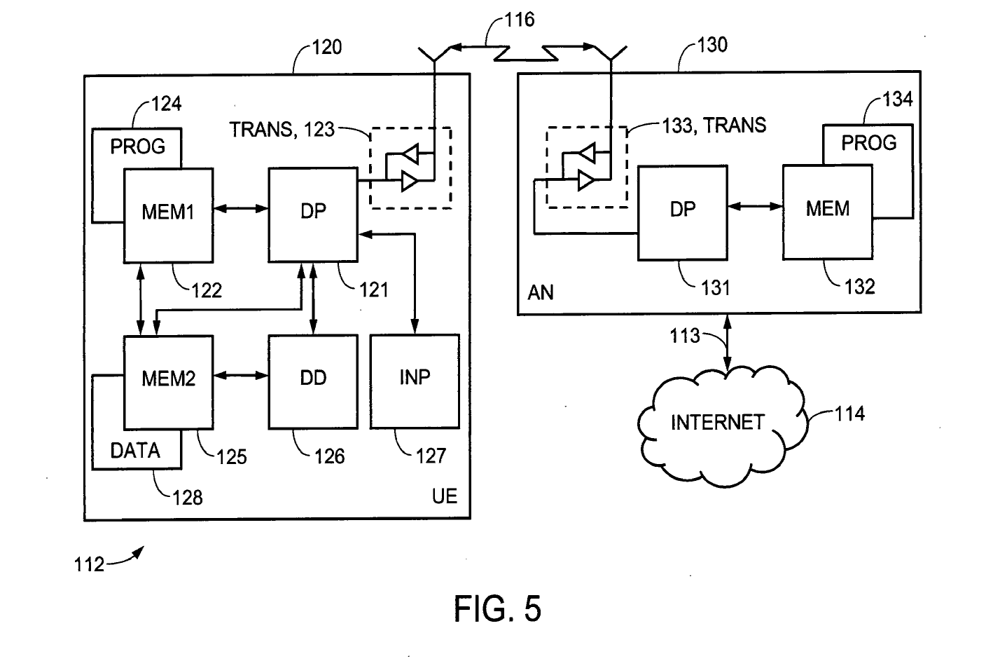

Reference is made to FIG. 5 for illustrating a simplified block diagram of various electronic devices that are suitable for use in practicing the exemplary embodiments of this invention. In FIG. 5, a wireless network 112 is adapted for communication with a user equipment (UE) 120 via an access node (AN) 130. The UE 120 includes at least one data processor (DP) 121, at least one first memory (MEM1) 122 coupled to the DP 121, and a transmitter (TX) and a receiver (RX) (e.g., a suitable RF transceiver (TRANS) 123) coupled to the DP 121. The MEM1 122 stores at least one program (PROG) 124. The transmitter and receiver (e.g., TRANS 123) are for bidirectional wireless communications with the AN 130. Note that the transmitter and receiver (e.g., TRANS 123) have (e.g., are coupled to) at least one antenna to facilitate communication.

The UE 120 also includes a second memory (MEM2) 125, a display device (DD) 126 and at least one user input component (INP) 127. The MEM2 125 stores image data (DATA) 128 and is coupled to the MEM1 122, DP 121 and DD 126. The DD 126 receives the DATA 128 from the MEM2 125 and is configured to display one or more corresponding 2D or S3D images based on the DATA 128. The DD 126 further is configured to receive and/or respond to commands from the DP 121. The INP 127 is coupled to the DP 121 and enables a user to input commands to and/or control the UE 120. The UE120 is a dual-mode device capable of displaying, in conjunction with the DD 126, a 2D image or a S3D image.

The AN 130 includes a data processor (DP) 131, a memory (MEM) 132 coupled to the DP 131, and a transmitter (TX) and a receiver (RX) (e.g., a suitable RF transceiver (TRANS) 133) coupled to the DP 131. The MEM 132 stores a program (PROG) 134. The transmitter and receiver (e.g., TRANS 133) is for wireless communication with the UE 120. Note that the transmitter and receiver (e.g., TRANS 133) have (e.g., are coupled to) at least one antenna to facilitate communication. The AN 130 is coupled via a data path 113 to one or more external networks or systems, such as the internet 114, for example.

At least one of the PROGs 124, 134 is assumed to include program instructions that, when executed by the associated DP 121, 131, enable the respective electronic device to operate in accordance with the exemplary embodiments of this invention, as discussed herein.

In general, the various exemplary embodiments of the UE 120 can include, but are not limited to, mobile nodes, mobile stations, mobile phones, cellular phones, personal digital assistants (PDAs) (e.g., having wireless communication capabilities), router, mobile routers, relays, relay stations, relay nodes, computers, stationary computers, portable computers (e.g., having wireless communication capabilities), image capture devices (e.g., digital cameras having wireless communication capabilities), gaming devices (e.g., having wireless communication capabilities), music storage and playback appliances (e.g., having wireless communication capabilities), Internet appliances (e.g., permitting wireless Internet access and browsing), mobile/portable electronic devices, global positioning system (GPS) units (e.g., having wireless communication capabilities), mobile/portable video-watching systems (e.g., mobile or portable DVD or Blu-Ray players having a screen), as well as stationary or portable units or terminals that incorporate combinations of such functions.

The exemplary embodiments of this invention may be implemented by computer software executable by one or more of the DPs 121, 131 of the UE 120 and the AN 130, or by hardware, or by a combination of software and hardware.

The MEMs 122, 125, 132 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The DPs 121, 131 may be of any type suitable to the local technical environment, and may include one or more of general purpose computers, special purpose computers, microprocessors, digital signal processors (DSPs) and processors based on a multi-core processor architecture, as non-limiting examples.

While described above in reference to memories (MEMS 122, 125, 132), these components may generally be seen to correspond to storage devices, storage circuits, storage components and/or storage blocks. In some exemplary embodiments, these components may comprise one or more computer-readable mediums, one or more computer-readable memories and/or one or more program storage devices.

While described above in reference to data processors (DPs 121, 131), these components may generally be seen to correspond to processors, processing devices, processing components, processing blocks, circuits, circuit devices, circuit components, circuit blocks, integrated circuits and/or chips (e.g., chips comprising one or more circuits and/or integrated circuits).

It should be noted that in some exemplary embodiments, the MEM1 122 comprises the MEM2 125 (i.e., the two memories are embodied within a single memory or a single memory component/device). In such exemplary embodiments, it may be that a portion of the MEM1 122 is reserved and/or utilized for storing image data in accordance with the exemplary embodiments of the invention. In further exemplary embodiments, the UE 112 may comprise one or more display processors coupled to the at least one display memory (MEM2 125) and to the DP 121.

In some exemplary embodiments, the INP 127 comprises at least one of the following: key(s), button(s), keyboard, number pad, touch pad, touch screen, switch, mouse, joystick, trackball, and/or any other suitable user interface (UI) component capable of receiving commands and/or information (e.g., from a user). The DD 126 may comprise one or more: display glass, plastic, screen, panel, mask, mask that is selectively active or selectively activated (e.g., active in the S3D mode, active in the S3D mode when showing a S3D image with S3D image data, inactive or deactivated in the 2D mode, inactive or deactivated in any mode other than the S3D mode), touch screen, touch panel, LCD, plasma screen, projector (e.g., with images being projected on a screen or other surface), and/or any other suitable display component.

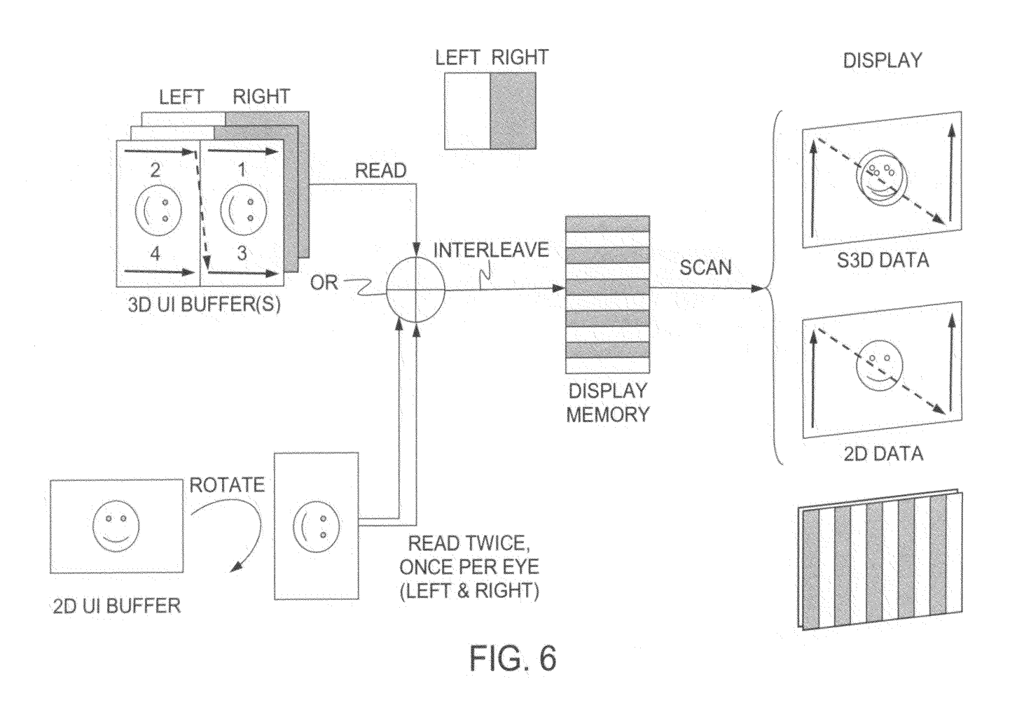

FIG. 6 illustrates an exemplary data path for an exemplary line interleaving S3D mode in accordance with various exemplary embodiments of the invention. In FIG. 6, it is assumed that the display is in S3D mode and will display an image based on either S3D image data (comprised of left image data and right image data) or 2D image data.

If the S3D image data is to be used, the S3D image data is read from the 3D user interface (UI) buffer(s), for example, in the order (1, 2, 3, 4) shown in FIG. 6. The left image data and the right image data are interleaved and then stored in the display memory. The stored interleaved image data is scanned and shown on the display as a S3D image (the image labeled “S3D DATA”).

If the 2D image data is to be used, the 2D image data in the 2D UI buffer is rotated before being read twice, once per eye/image (left image and right image). The twice-read 2D image data is “interleaved” and subsequently stored in the display memory. Note that this interleaving results in both the left image and the right image being based on the same data (i.e., the 2D image data). The stored “interleaved” image data is scanned and shown on the display as a “flat” S3D image that is based on the 2D image data (the image labeled “2D DATA”).

In some exemplary embodiments, the UI buffers are double and/or triple buffered. The rendering may happen to the backbuffer, which is not bound to the screen update. Thus, the rendering would not cause tearing. As non-limiting examples, the UI rotation maybe performed by memory-to-memory techniques or on the fly. As non-limiting examples, the left image data and the right image data, as stored in the 3D UI buffer(s), each may be of size 360×640 for a total image size of 720×640. As a non-limiting example, the interleaving may be at 360×1280×3 over Display Serial Interface-2 (DSI-2) in side-by-side full mode.

In some exemplary embodiments, one lens covers two lines, right and left, though odd and even lines would have to be in sync. In some exemplary embodiments, DMA is triggered when the process first begins and VS falling (e.g., 30 fps). The VS may be raised for 60 fps (e.g., if two lines can be sent during VS, otherwise line 1279 can trigger the DMA). In some exemplary embodiments, and as shown in the bottom-most picture of the display in FIG. 6, in landscape mode the first line from the left side may be right (eye) image data. In other exemplary embodiments, the first line from the left side may be left (eye) image data. It is noted that in some exemplary embodiments of the invention, a goal of tearing-free updates at a given draw rate (frames per second or fps) may be indicative of a corresponding target transfer speed. As non-limiting examples, the draw rate can vary from 30-60 fps. As non-limiting examples, corresponding transfer speeds may range from 15-30 ms. In further exemplary embodiments, there may be a minimum transfer speed. As non-limiting examples, such a minimum transfer speed may range from 150 Mbps to 700 Mbps. In some exemplary embodiments, the minimum transfer speed may be based on the draw rate and/or the DSI mode utilized, as non-limiting examples.

In some exemplary embodiments, with an interleaving line technique in the 2D mode (and with 2× memory) every two lines are duplicated. In some exemplary embodiments, with an interleaving line technique in the S3D mode the eye sees every second physical line. It is noted that with a S3D panel having 1× resolution memory, in the changing mode (e.g., switching from 2D mode to S3D mode) every second pixel is read.

While described above with respect to a line interleaving S3D mode, in other exemplary embodiments a different type of S3D mode may be utilized, such as pixel interleaved and total right image data followed by total left image data, as non-limiting examples. Any suitable S3D mode and/or technique may be utilized in conjunction with the exemplary embodiments of the invention.

In some exemplary embodiments, the display scanning speed (e.g., 60 Hz=16 ms) is faster than the memory writing speed (e.g., 30 Hz=32 ms). In some exemplary embodiments, in the 2D mode every transmitted line is duplicated to the display memory (e.g., with the panel scanning every bit from the display memory). In such a case, the duplication is in the memory writing phase rather than the scanning phase. This works with 2× resolution.

The following are provided as non-limiting examples of various benefits and/or improvements that may be realized in conjunction with practice of the exemplary embodiments of the invention. The impact of time-critical issues is reduced when switching between 2D and S3D modes. In addition, extra or additional memory (e.g., beyond a single, shared memory for both modes) is not needed. Furthermore, the appearance of corrupted frames during switching can be avoided and/or reduced.

It is noted that for some S3D-enabled devices (e.g., S3D-enabled mobile devices), a mask above the pixels works such that each eye only sees every other pixel (every second pixel) with the left and right eyes being unable to see the same pixel (e.g., due to the mask hiding certain pixels from each eye). In such a manner, special glasses may not be needed to view the S3D image. As known to one of ordinary skill in the art, various techniques exist to enable and/or disable the mask (e.g., making the mask selectively active). Another S3D viewing technique is to use a “bubble” per pixel pair (e.g., as a lens), which may be switchable as well. The exemplary embodiments of the invention may be utilized in conjunction with any suitable S3D viewing technique including ones that use a mask, a lens, a “bubble” and/or special S3D viewing glasses, lenses or a lens, as non-limiting examples.

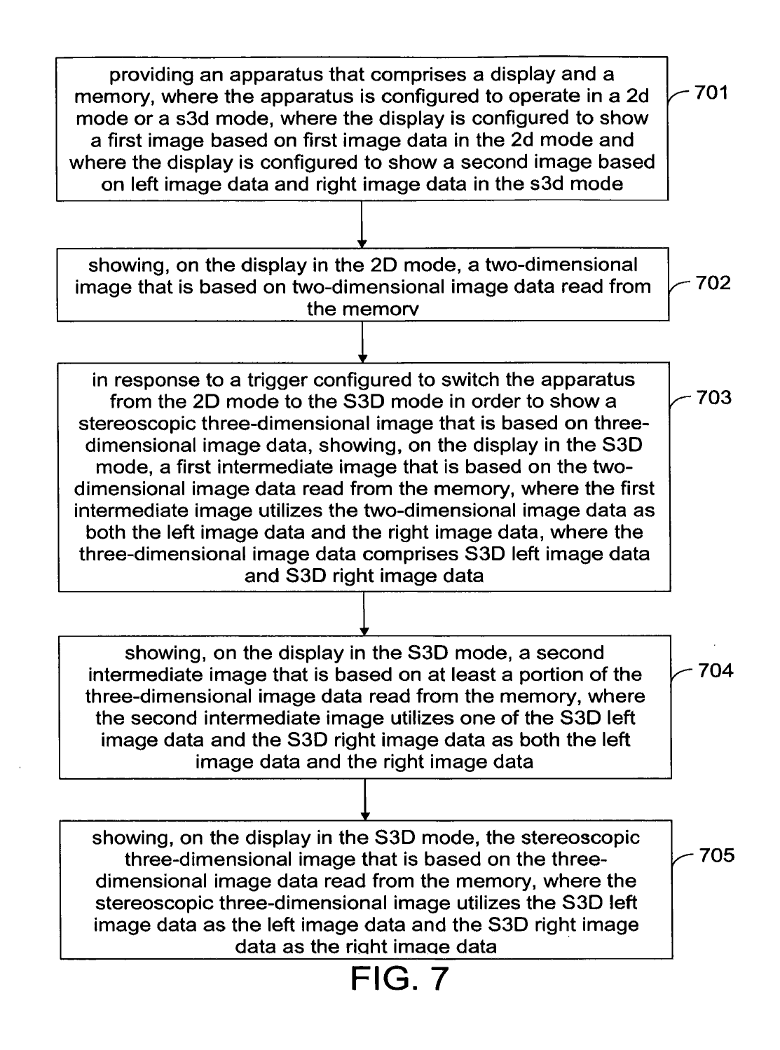

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.
(1) In one exemplary embodiment, and with reference to FIG. 7, a method comprising: providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode (701); showing, on the display in the 2D mode, a two-dimensional image that is based on two-dimensional image data read from the memory (702); in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the memory, where the first intermediate image utilizes the two-dimensional image data as both the left image data and the right image data, where the three-dimensional image data comprises S3D left image data and S3D right image data (703); showing, on the display in the S3D mode, a second intermediate image that is based on at least a portion of the three-dimensional image data read from the memory, where the second intermediate image utilizes one of the S3D left image data and the S3D right image data as both the left image data and the right image data (704); and showing, on the display in the S3D mode, the stereoscopic three-dimensional image that is based on the three-dimensional image data read from the memory, where the stereoscopic three-dimensional image utilizes the S3D left image data as the left image data and the S3D right image data as the right image data (705).

A method as above, where showing the second intermediate image is performed in response to completion or termination of a direct memory access transfer that loads the three-dimensional image data in the memory. A method as in any above, where the trigger comprises at least one of a command and detection, by the apparatus, that the stereoscopic three-dimensional image is to be displayed on the display. A method as in any above, where the trigger comprises a first trigger, where showing the second intermediate image is performed in response to a second trigger, where the second trigger comprises at least one of a command and detection that the three-dimensional image data has been loaded in the memory. A method as in any above, where the first intermediate image utilizes line-interleaved data or pixel-interleaved data, where the first intermediate image is based on interleaving two copies of the two-dimensional image data. A method as in any above, where the second intermediate image utilizes line-interleaved data or pixel-interleaved data, where the second intermediate image is based on interleaving two copies of the S3D left image data or two copies of the S3D right image data. A method as in any above, where the method is operable to reduce or eliminate visible tearing, errors or corruption in images shown on the display while the apparatus switches from the 2D mode to the S3D mode.

A method as in any above, further comprising: in response to a second trigger configured to switch the apparatus from the S3D mode to the 2D mode in order to show a second two-dimensional image that is based on second two-dimensional image data, showing, on the display in the 2D mode, a third intermediate image that is based on the three-dimensional image data read from the memory, where the third intermediate image utilizes one of the S3D left image data and the S3D right image data as the first image data; showing, on the display in the 2D mode, a fourth intermediate image that is based on the second two-dimensional image data read from the memory, where the fourth intermediate image utilizes the second two-dimensional image data by reading the second two-dimensional image data at least twice or by reading at least two copies of the second two-dimensional image data; and showing, on the display in the 2D mode, the second two-dimensional image that is based on the second two-dimensional image data read from the memory, where the second two-dimensional image utilizes the second two-dimensional image data by reading the second two-dimensional image data only once or by reading only one copy of the second two-dimensional image data.

A method as in any above, implemented as a computer program. A method as in any above, implemented as a computer program stored (e.g., tangibly embodied) on a computer-readable medium (e.g., a program storage device, a memory). A computer program comprising computer program instructions that, when loaded in a processor, perform operations according to one or more (e.g., any one) of the above-described methods. A method as in any above, implemented as a program of instructions tangibly embodied on a program storage device, execution of the program of instructions by a machine (e.g., a processor or a data processor) resulting in operations comprising the steps of the method. A method as in any above, further comprising one or more aspects (e.g., one or more further aspects) of the exemplary embodiments of the invention as described herein.
(2) In another exemplary embodiment, a program storage device readable by a machine, tangibly embodying a program of instructions executable by the machine for performing operations, said operations comprising: providing an apparatus that comprises a display and a memory, where the apparatus is configured to operate in a 2D mode or a

S3D mode, where the display is configured to show a first image based on first image data in the 2D mode and where the display is configured to show a second image based on left image data and right image data in the S3D mode (701); showing, on the display in the 2D mode, a two-dimensional image that is based on two-dimensional image data read from the memory (702); in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the memory, where the first intermediate image utilizes the two-dimensional image data as both the left image data and the right image data, where the three-dimensional image data comprises S3D left image data and S3D right image data (703); showing, on the display in the S3D mode, a second intermediate image that is based on at least a portion of the three-dimensional image data read from the memory, where the second intermediate image utilizes one of the S3D left image data and the S3D right image data as both the left image data and the right image data (704); and showing, on the display in the S3D mode, the stereoscopic three-dimensional image that is based on the three-dimensional image data read from the memory, where the stereoscopic three-dimensional image utilizes the S3D left image data as the left image data and the S3D right image data as the right image data (705).

A program storage device as in any above, wherein the program storage device comprises a computer-readable medium, a computer-readable memory, a memory, a memory card, a removable memory, a storage device, a storage component and/or a storage circuit. A program storage device as in any above, further comprising one or more aspects (e.g., one or more further aspects) of the exemplary embodiments of the invention as described herein.
(3) In another exemplary embodiment, an apparatus comprising: a display; at least one processor; and at least one memory including computer program code, where the apparatus is configured to operate in a 2D mode or a S3D mode, where the display is configured to show a first image based on first image data in the 2D mode and where the display is configured to show a second image based on left image data and right image data in the S3D mode, the at least one memory and the computer program code being configured to, with the at least one processor, cause the apparatus at least to perform: showing, on the display in the 2D mode, a two-dimensional image that is based on two-dimensional image data read from the at least one memory; in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the at least one memory, where the first intermediate image utilizes the two-dimensional image data as both the left image data and the right image data, where the three-dimensional image data comprises S3D left image data and S3D right image data; showing, on the display in the S3D mode, a second intermediate image that is based on at least a portion of the three-dimensional image data read from the at least one memory, where the second intermediate image utilizes one of the S3D left image data and the S3D right image data as both the left image data and the right image data; and showing, on the display in the S3D mode, the stereoscopic three-dimensional image that is based on the three-dimensional image data read from the at least one memory, where the stereoscopic three-dimensional image utilizes the S3D left image data as the left image data and the S3D right image data as the right image data.

An apparatus as above, further comprising at least one vision component configured to enable a first portion of images shown on the display in the S3D mode to be substantially visible to a left eye of a viewer but not to a right eye of the viewer, where the at least one vision component is further configured to enable a second portion of images shown on the display in the S3D mode to be substantially visible to the right eye of the viewer but not to the left eye of the viewer. An apparatus as in any above, where the at least one vision component comprises at least one of a mask, a lens and a bubble lens per pixel pair. An apparatus as in any above, where the apparatus comprises a mobile device, a mobile node, a mobile phone or a cellular phone.

An apparatus as in any above, further comprising at least one user input component configured to receive at least one command, control signal or input from a user. An apparatus as in any above, where the at least one memory comprises a system memory and at least one of a 1× resolution display memory and a 2× resolution display memory. An apparatus as in any above, where the at least one memory is configured to store display image data for images that are to be shown in the display, where the at least one memory is configured to store the two-dimensional image data or the three-dimensional image data, where the at least one memory is configured to not store both the two-dimensional image data and the three-dimensional image data at a same time. An apparatus as in any above, further comprising at least one wireless communication component configured to enable wireless communication with another apparatus. An apparatus as in any above, further comprising at least one mask. An apparatus as in any above, further comprising one or more aspects (e.g., one or more further aspects) of the exemplary embodiments of the invention as described herein.
(4) In another exemplary embodiment, an apparatus comprising: means for storing image data; and means for displaying a first image based on first image data in a 2D mode, where the means for displaying is further for showing a second image based on left image data and right image data in a S3D mode, where the apparatus is configured to operate in the 2D mode or the S3D mode, where the means for display is further for showing, in the 2D mode, a two-dimensional image that is based on two-dimensional image data read from the means for storing, where the means for display is further for, in response to a trigger configured to switch the apparatus from the 2D mode to the S3D mode in order to show a stereoscopic three-dimensional image that is based on three-dimensional image data, showing, in the S3D mode, a first intermediate image that is based on the two-dimensional image data read from the means for storing, where the first intermediate image utilizes the two-dimensional image data as both the left image data and the right image data, where the three-dimensional image data comprises S3D left image data and S3D right image data, where the means for display is further for showing, in the S3D mode, a second intermediate image that is based on at least a portion of the three-dimensional image data read from the means for storing, where the second intermediate image utilizes one of the S3D left image data and the S3D right image data as both the left image data and the right image data, where the means for display is further for showing, in the S3D mode, the stereoscopic three-dimensional image that is based on the three-dimensional image data read from the means for storing, where the stereoscopic three-dimensional image utilizes the S3D left image data as the left image data and the S3D right image data as the right image data.

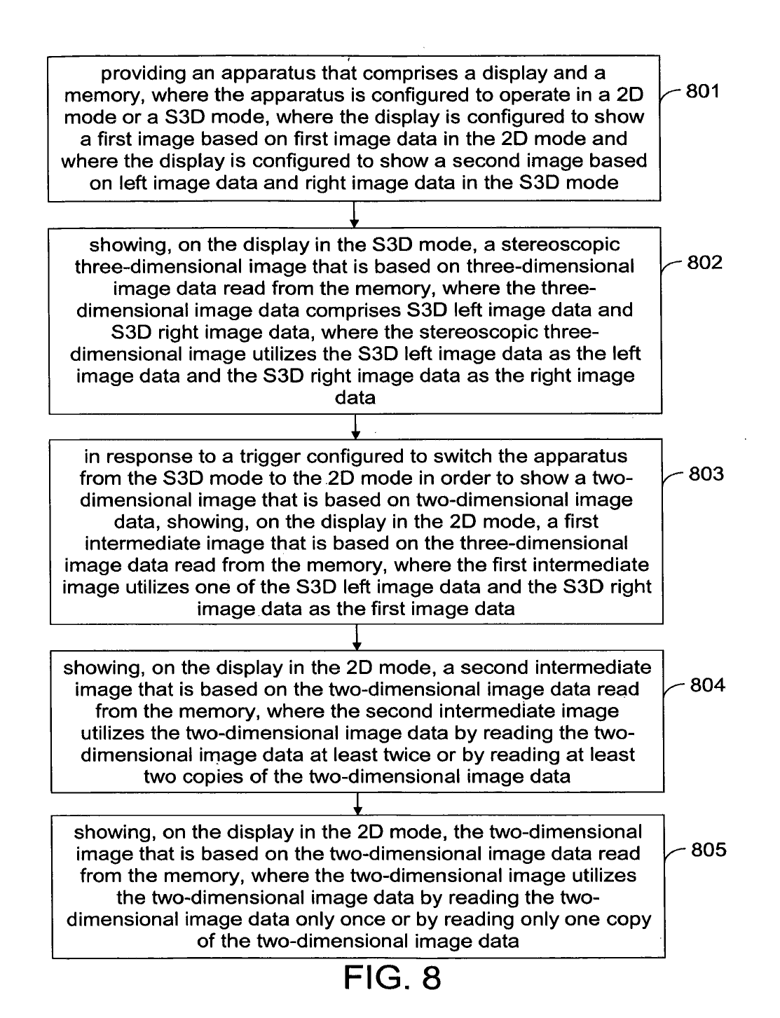

An apparatus as in any above, where the means for storing comprises at least one memory and the means for display comprises a display device (e.g., a dual-mode display device, a dual-mode display device configured to show a two-dimensional image in the 2D mode and a three-dimensional image in the S3D mode). An apparatus as in any above, further comprising one or more aspects (e.g., one or more further aspects) of the exemplary embodiments of the invention as described herein.
(5) In one exemplary embodiment, and with reference to FIG. 8, a method comprising: providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode (801); showing, on the display in the S3D mode, a stereoscopic three-dimensional image that is based on three-dimensional image data read from the memory, where the three-dimensional image data comprises S3D left image data and S3D right image data, where the stereoscopic three-dimensional image utilizes the S3D left image data as the left image data and the S3D right image data as the right image data (802); in response to a trigger configured to switch the apparatus from the S3D mode to the 2D mode in order to show a two-dimensional image that is based on two-dimensional image data, showing, on the display in the 2D mode, a first intermediate image that is based on the three-dimensional image data read from the memory, where the first intermediate image utilizes one of the S3D left image data and the S3D right image data as the first image data (803); showing, on the display in the 2D mode, a second intermediate image that is based on the two-dimensional image data read from the memory, where the second intermediate image utilizes the two-dimensional image data by reading the two-dimensional image data at least twice or by reading at least two copies of the two-dimensional image data (804); and showing, on the display in the 2D mode, the two-dimensional image that is based on the two-dimensional image data read from the memory, where the two-dimensional image utilizes the two-dimensional image data by reading the two-dimensional image data only once or by reading only one copy of the two-dimensional image data (805).

A method as in any above, where showing the second intermediate image is performed in response to completion or termination of a direct memory access transfer that loads the two-dimensional image data in the memory. A method as in any above, where the trigger comprises at least one of a command and detection, by the apparatus, that the two-dimensional image is to be displayed on the display. A method as in any above, where the trigger comprises a first trigger, where showing the second intermediate image is performed in response to a second trigger, where the second trigger comprises at least one of a command and detection that the two-dimensional image data has been loaded in the memory.

A method as in any above, implemented as a computer program. A method as in any above, implemented as a computer program stored (e.g., tangibly embodied) on a computer-readable medium (e.g., a program storage device, a memory). A computer program comprising computer program instructions that, when loaded in a processor, perform operations according to one or more (e.g., any one) of the above-described methods. A method as in any above, implemented as a program of instructions tangibly embodied on a program storage device, execution of the program of instructions by a machine (e.g., a processor or a data processor) resulting in operations comprising the steps of the method. A method as in any above, further comprising one or more aspects (e.g., one or more further aspects) of the exemplary embodiments of the invention as described herein.
(6) In another exemplary embodiment, a program storage device readable by a machine, tangibly embodying a program of instructions executable by the machine for performing operations, said operations comprising: providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode (801); showing, on the display in the S3D mode, a stereoscopic three-dimensional image that is based on three-dimensional image data read from the memory, where the three-dimensional image data comprises S3D left image data and S3D right image data, where the stereoscopic three-dimensional image utilizes the S3D left image data as the left image data and the S3D right image data as the right image data (802); in response to a trigger configured to switch the apparatus from the S3D mode to the 2D mode in order to show a two-dimensional image that is based on two-dimensional image data, showing, on the display in the 2D mode, a first intermediate image that is based on the three-dimensional image data read from the memory, where the first intermediate image utilizes one of the S3D left image data and the S3D right image data as the first image data (803); showing, on the display in the 2D mode, a second intermediate image that is based on the two-dimensional image data read from the memory, where the second intermediate image utilizes the two-dimensional image data by reading the two-dimensional image data at least twice or by reading at least two copies of the two-dimensional image data (804); and showing, on the display in 2D mode, the two-dimensional image that is based on the two-dimensional image data read from the memory, where the two-dimensional image utilizes the two-dimensional image data by reading the two-dimensional image data only once or by reading only one copy of the two-dimensional image data (805).

A program storage device as in any above, wherein the program storage device comprises a computer-readable medium, a computer-readable memory, a memory, a memory card, a removable memory, a storage device, a storage component and/or a storage circuit. A program storage device as in any above, further comprising one or more aspects (e.g., one or more further aspects) of the exemplary embodiments of the invention as described herein.
(7) In another exemplary embodiment, an apparatus comprising: a display; at least one processor; and at least one memory including computer program code, where the apparatus is configured to operate in a 2D mode or a S3D mode, where the display is configured to show a first image based on first image data in the 2D mode and where the display is configured to show a second image based on left image data and right image data in the S3D mode, the at least one memory and the computer program code being configured to, with the at least one processor, cause the apparatus at least to perform: showing, on the display in the S3D mode, a stereoscopic three-dimensional image that is based on three-dimensional image data read from the at least one memory, where the three-dimensional image data comprises S3D left image data and S3D right image data, where the stereoscopic three-dimensional image utilizes the S3D left image data as the left image data and the S3D right image data as the right image data; in response to a trigger configured to switch the apparatus from the S3D mode to the 2D mode in order to show a two-dimensional image that is based on two-dimensional image data, showing, on the display in the 2D mode, a first intermediate image that is based on the three-dimensional image data read from the at least one memory, where the first intermediate image utilizes one of the S3D left image data and the S3D right image data as the first image data; showing, on the display in the 2D mode, a second intermediate image that is based on the two-dimensional image data read from the at least one memory, where the second intermediate image utilizes the two-dimensional image data by reading the two-dimensional image data at least twice or by reading at least two copies of the two-dimensional image data; and showing, on the display in the 2D mode, the two-dimensional image that is based on the two-dimensional image data read from the at least one memory, where the two-dimensional image utilizes the two-dimensional image data by reading the two-dimensional image data only once or by reading only one copy of the two-dimensional image data.

An apparatus as in any above, further comprising one or more aspects (e.g., one or more further aspects) of the exemplary embodiments of the invention as described herein.
(8) In another exemplary embodiment, an apparatus comprising: means for storing image data; and means for displaying a first image based on first image data in the 2D mode, where the means for displaying is further for showing a second image based on left image data and right image data in a S3D mode, where the apparatus is configured to operate in the 2D mode or the S3D mode, where the means for display is further for showing, in the S3D mode, a stereoscopic three-dimensional image that is based on three-dimensional image data read from the means for storing, where the three-dimensional image data comprises S3D left image data and S3D right image data, where the stereoscopic three-dimensional image utilizes the S3D left image data as the left image data and the S3D right image data as the right image data, where the means for display is further for in response to a trigger configured to switch the apparatus from the S3D mode to the 2D mode in order to show a two-dimensional image that is based on two-dimensional image data, showing, in the 2D mode, a first intermediate image that is based on the three-dimensional image data read from the means for storing, where the first intermediate image utilizes one of the S3D left image data and the S3D right image data as the first image data, where the means for display is further for showing, in the 2D mode, a second intermediate image that is based on the two-dimensional image data read from the means for storing, where the second intermediate image utilizes the two-dimensional image data by reading the two-dimensional image data at least twice or by reading at least two copies of the two-dimensional image data, where the means for display is further for showing, in the 2D mode, the two-dimensional image that is based on the two-dimensional image data read from the means for storing, where the two-dimensional image utilizes the two-dimensional image data by reading the two-dimensional image data only once or by reading only one copy of the two-dimensional image data.

An apparatus as in any above, where the means for storing comprises at least one memory and the means for display comprises a display device (e.g., a dual-mode display device, a dual-mode display device configured to show a two-dimensional image in the 2D mode and a three-dimensional image in the S3D mode). An apparatus as in any above, further comprising one or more aspects (e.g., one or more further aspects) of the exemplary embodiments of the invention as described herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device (e.g., a computer-readable medium, a memory) readable by a machine (e.g., a computer, a mobile station, a mobile device, a mobile node), tangibly embodying a program of instructions (e.g., a program, a computer program) executable by the machine for performing operations. The operations comprise steps of utilizing the exemplary embodiments or steps of the method.

The various blocks shown in FIGS. 7 and 8 may be viewed as method steps, as operations that result from operation of computer program code and/or as one or more coupled components (e.g., function blocks, circuits, integrated circuits, logic circuit elements) constructed to carry out the associated function(s). The blocks depicted in FIGS. 7 and 8 may also be considered to correspond to one or more functions and/or operations that are performed by one or more components, apparatus, processors, computer programs, circuits, integrated circuits, application-specific integrated circuits (ASICs), chips and/or function blocks. Any and/or all of the above may be implemented in any practicable arrangement or solution that enables operation in accordance with the exemplary embodiments of the invention.

Furthermore, the arrangement of the blocks shown in FIGS. 7 and 8 should be considered merely exemplary and non-limiting. It should be appreciated that the blocks depicted in FIGS. 7 and 8 may correspond to one or more functions and/or operations that may be performed in any order (e.g., any practicable, suitable and/or feasible order) and/or concurrently (e.g., as practicable, suitable and/or feasible) so as to implement one or more of the exemplary embodiments of the invention. In addition, one or more additional steps, functions and/or operations may be utilized in conjunction with those illustrated in FIGS. 7 and 8 so as to implement one or more further exemplary embodiments of the invention, such as those described in further detail herein.

That is, the non-limiting, exemplary embodiments of the invention shown in FIGS. 7 and 8 may be implemented, practiced or utilized in conjunction with one or more further aspects in any combination (e.g., any combination that is practicable, suitable and/or feasible) and are not limited only to the blocks, steps, functions and/or operations illustrated in FIGS. 7 and 8.

While illustrated above with respect to various S3D displays, methods, techniques, devices and components, it should be appreciated that any suitable S3D display, method, technique, device and/or component may be utilized in conjunction with the exemplary embodiments of the invention as described herein. As a non-limiting example, while illustrated with exemplary arrangements of left/right eye data (e.g., as shown in FIG. 6), it should be appreciated that the exemplary embodiments of the invention are not limited to only these arrangements of left/right eye data and that, for example, the depicted arrangements may be reversed (e.g., with the left eye data being the shaded elements of FIG. 6; and/or with the buffers being read in a different order). One of ordinary skill in the art will appreciate the various combinations and arrangements that may be utilized.

While described above primarily with respect to one or more display memories, it should be appreciated that the exemplary embodiments of the invention may be utilized in conjunction with a “memoryless” display (i.e., a device that does not have a separate memory for display images). As a non-limiting example, the exemplary embodiments of the invention may be utilized in conjunction with image data that is stored in shared memory and/or system memory.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical region (both visible and invisible), as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controllers, other computing devices and/or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode;
showing, on the display in the 2D mode, a two-dimensional image that is based on two-dimensional image data read from the memory;
in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the memory, where the first intermediate image utilizes the two-dimensional image data as both the left image data and the right image data, where the three-dimensional image data comprises S3D left image data and S3D right image data;
showing, on the display in the S3D mode, a second intermediate image that is based on at least a portion of the three-dimensional image data read from the memory, where the second intermediate image utilizes one of the S3D left image data and the S3D right image data as both the left image data and the right image data; and
showing, on the display in the S3D mode, the stereoscopic three-dimensional image that is based on the three-dimensional image data read from the memory, where the stereoscopic three-dimensional image utilizes the S3D left image data as the left image data and the S3D right image data as the right image data.

2. The method of claim 1, where showing the second intermediate image is performed in response to completion or termination of a direct memory access transfer that loads the three-dimensional image data in the memory.

3. The method of claim 1, where the trigger comprises at least one of a command and detection, by the apparatus, that the stereoscopic three-dimensional image is to be displayed on the display.

4. The method of claim 1, where the trigger comprises a first trigger, where showing the second intermediate image is performed in response to a second trigger, where the second trigger comprises at least one of a command and detection that the three-dimensional image data has been loaded in the memory.

5. The method of claim 1, where the first intermediate image utilizes line-interleaved data or pixel-interleaved data, where the first intermediate image is based on interleaving two copies of the two-dimensional image data.

6. The method of claim 1, where the second intermediate image utilizes line-interleaved data or pixel-interleaved data, where the second intermediate image is based on interleaving two copies of the S3D left image data or two copies of the S3D right image data.

7. The method of claim 1, where the method is operable to reduce or eliminate visible tearing, errors or corruption in images shown on the display while the apparatus switches from the 2D mode to the S3D mode.

8. The method of claim 1, further comprising:
in response to a second trigger configured to switch the apparatus from the S3D mode to the 2D mode in order to show a second two-dimensional image that is based on second two-dimensional image data, showing, on the display in the 2D mode, a third intermediate image that is based on the three-dimensional image data read from the memory, where the third intermediate image utilizes one of the S3D left image data and the S3D right image data as the first image data;
showing, on the display in the 2D mode, a fourth intermediate image that is based on the second two-dimensional image data read from the memory, where the fourth intermediate image utilizes the second two-dimensional image data by reading the second two-dimensional image data at least twice or by reading at least two copies of the second two-dimensional image data; and
showing, on the display in the 2D mode, the second two-dimensional image that is based on the second two-dimensional image data read from the memory, where the second two-dimensional image utilizes the second two-dimensional image data by reading the second two-dimensional image data only once or by reading only one copy of the second two-dimensional image data.

9. An apparatus comprising: a display; at least one processor; and at least one memory including computer program code, where the apparatus is configured to operate in a 2D mode or a S3D mode, where the display is configured to show a first image based on first image data in the 2D mode and where the display is configured to show a second image based on left image data and right image data in the S3D mode, the at least one memory and the computer program code being configured to, with the at least one processor, cause the apparatus at least to perform:
showing, on the display in the 2D mode, a two-dimensional image that is based on two-dimensional image data read from the at least one memory;
in response to a trigger configured to switch the apparatus from the 2D mode to the S3D mode in order to show a stereoscopic three-dimensional image that is based on three-dimensional image data, showing, on the display in the S3D mode, a first intermediate image that is based on the two-dimensional image data read from the at least one memory, where the first intermediate image utilizes the two-dimensional image data as both the left image data and the right image data, where the three-dimensional image data comprises S3D left image data and S3D right image data;
showing, on the display in the S3D mode, a second intermediate image that is based on at least a portion of the three-dimensional image data read from the at least one memory, where the second intermediate image utilizes one of the S3D left image data and the S3D right image data as both the left image data and the right image data; and
showing, on the display in the S3D mode, the stereoscopic three-dimensional image that is based on the three-dimensional image data read from the at least one memory, where the stereoscopic three-dimensional image utilizes the S3D left image data as the left image data and the S3D right image data as the right image data.

10. The apparatus of claim 9, further comprising at least one vision component configured to enable a first portion of images shown on the display in the S3D mode to be substantially visible to a left eye of a viewer but not to a right eye of the viewer, where the at least one vision component is further configured to enable a second portion of images shown on the display in the S3D mode to be substantially visible to the right eye of the viewer but not to the left eye of the viewer.

11. The apparatus of claim 10, where the at least one vision component comprises at least one of a mask, a lens and a bubble lens per pixel pair.

12. The apparatus of claim 9, where the apparatus comprises a mobile device, a mobile node, a mobile phone or a cellular phone.

13. The apparatus of claim 9, further comprising at least one user input component configured to receive at least one command, control signal or input from a user.

14. The apparatus of claim 9, where the at least one memory comprises a system memory and at least one of a 1× resolution display memory and a 2× resolution display memory.

15. The apparatus of claim 9, where the at least one memory is configured to store display image data for images that are to be shown in the display, where the at least one memory is configured to store the two-dimensional image data or the three-dimensional image data, where the at least one memory is configured to not store both the two-dimensional image data and the three-dimensional image data at a same time.

16. The apparatus of claim 9, further comprising at least one wireless communication component configured to enable wireless communication with another apparatus.

17. A method comprising:
providing an apparatus that comprises a display and a memory, where the apparatus is configured to operate in a 2D mode or a S3D mode, where the display is configured to show a first image based on first image data in the 2D mode and where the display is configured to show a second image based on left image data and right image data in the S3D mode;
showing, on the display in the S3D mode, a stereoscopic three-dimensional image that is based on three-dimensional image data read from the memory, where the three-dimensional image data comprises S3D left image data and S3D right image data, where the stereoscopic three-dimensional image utilizes the S3D left image data as the left image data and the S3D right image data as the right image data;
in response to a trigger configured to switch the apparatus from the S3D mode to the 2D mode in order to show a two-dimensional image that is based on two-dimensional image data, showing, on the display in the 2D mode, a first intermediate image that is based on the three-dimensional image data read from the memory, where the first intermediate image utilizes one of the S3D left image data and the S3D right image data as the first image data;
showing, on the display in the 2D mode, a second intermediate image that is based on the two-dimensional image data read from the memory, where the second intermediate image utilizes the two-dimensional image data by reading the two-dimensional image data at least twice or by reading at least two copies of the two-dimensional image data; and
showing, on the display in the 2D mode, the two-dimensional image that is based on the two-dimensional image data read from the memory, where the two-dimensional image utilizes the two-dimensional image data by reading the two-dimensional image data only once or by reading only one copy of the two-dimensional image data.

18. The method of claim 17, where showing the second intermediate image is performed in response to completion or termination of a direct memory access transfer that loads the two-dimensional image data in the memory.

19. The method of claim 17, where the trigger comprises at least one of a command and detection, by the apparatus, that the two-dimensional image is to be displayed on the display.

20. The method of claim 17, where the trigger comprises a first trigger, where showing the second intermediate image is performed in response to a second trigger, where the second trigger comprises at least one of a command and detection that the two-dimensional image data has been loaded in the memory.
